(19) United States
(12) Patent Application Publication
(10) Pub. No.: US 2023/0296220 A1
(43) Pub. Date: Sep. 21, 2023

(54) LAMP BODY

(71) Applicant: HONDA MOTOR CO., LTD., Tokyo (JP)

(72) Inventors: Shoji INOSE, Saitama (JP); Masaki NAMAIZAWA, Saitama (JP); Tadahisa NAKAMURA, Saitama (JP); Kazuo TAKEUCHI, Saitama (JP)

(21) Appl. No.: 18/173,793

(22) Filed: Feb. 24, 2023

(30) Foreign Application Priority Data
Mar. 15, 2022 (JP) 2022-040594

(51) Int. Cl. F21S 41/29; F21S 41/20; F21S 45/60

(52) U.S. Cl. CPC F21S 41/29; F21S 41/28; F21S 45/60

(57) ABSTRACT

A lamp body includes a housing to be attached to a vehicle body, and a lens joined to the housing. The lens includes a heat-generating region that allows for heat generation.

This application is based on and claims the benefit of priority from Japanese Patent Application No. 2022-040594, filed on 15 Mar. 2022, the content of which is incorporated herein by reference.

### BACKGROUND OF THE INVENTION

### Field of the Invention

The present invention relates to a lamp body.

### Related Art

Conventionally, the recycling of a lamp body attached to a vehicle has been studied.

Japanese Unexamined Patent Application, Publication No. 2007-15453 discloses a lamp body including a recessed seal sump provided in a housing, a seal leg portion provided in a lens, and a seal member interposed between the seal sump and the seal leg portion. At this time, in order to mitigate impact when an object collides with the lens and prevent the lens from falling off, the seal sump is provided with a rupture part which is ruptured when a stress is applied to the lens, thereby moving the lens toward the housing.

Patent Document 1: Japanese Unexamined Patent Application, Publication No. 2007-15453

### SUMMARY OF THE INVENTION

However, it is desirable for the lamp body to have high rigidity and allow a lens to be easily separated when recycling.

It is an object of the present invention to provide a lamp body that has high rigidity and allows a lens to be easily separated when recycling.

An embodiment of the present invention provides a lamp body including a housing to be attached to a vehicle body, and a lens joined to the housing, in which the lens includes a heat-generating region that allows for heat generation.

The heat-generating region may be provided in a region of the lens joined to the housing, or in a vicinity of the region.

The lens may include a rib joined to a lens body and the housing, and the heat-generating region may be provided in the rib.

The lens may include a rib joined to a lens body and the housing, and the heat-generating region may be provided in a vicinity of an inner side in a plane direction with respect to the rib of the lens body.

The heat-generating region may include a filler capable of generating heat by irradiation with an electromagnetic wave, or a coating layer capable of generating heat by irradiation with an electromagnetic wave thereon.

The heat-generating region may be a conductive member capable of generating heat by resistance heating, and the conductive member may be connectable to a power source.

The lens may include a soluble region which can be dissolved by a solvent instead of the heat-generating region.

The lens may have a projecting shape with respect to the vehicle body, and the housing may include a pressure adjustment hole.

According to an embodiment of the present invention, it is possible to provide a lamp body that has high rigidity and allows a lens to be easily separated when recycling.

### BRIEF DESCRIPTION OF THE DRAWINGS

FIGS. 1A and 1B are each a cross-sectional view of an example of a lamp body of an embodiment of the present embodiment;

FIG. 2 is a top view of the lamp body of FIGS. 1A and 1B;

FIG. 3 is a cross-sectional view of a modified example of the lens of FIGS. 1A and 1B; and

FIGS. 4A and 4B are each a cross-sectional view of a modified example of the lenses of FIGS. 1A and 1B.

### DETAILED DESCRIPTION OF THE INVENTION

Hereinafter, embodiments of the present invention will be described with reference to the accompanying drawings.

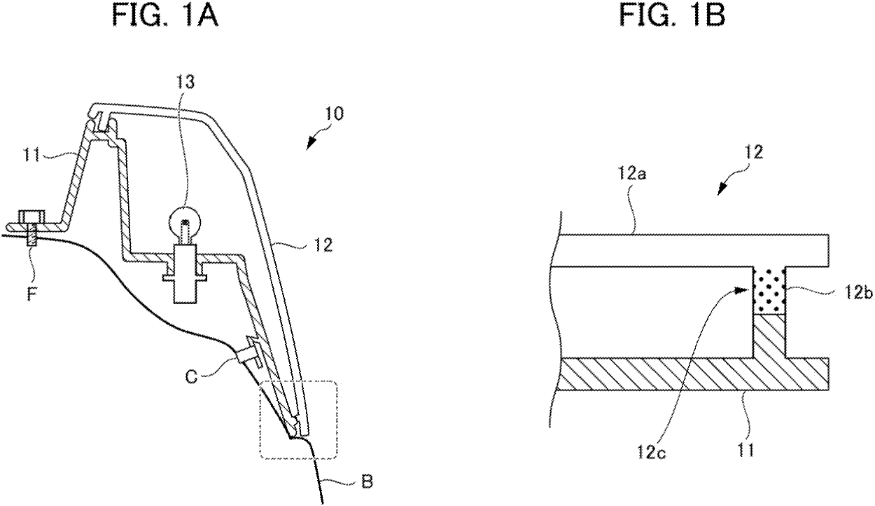

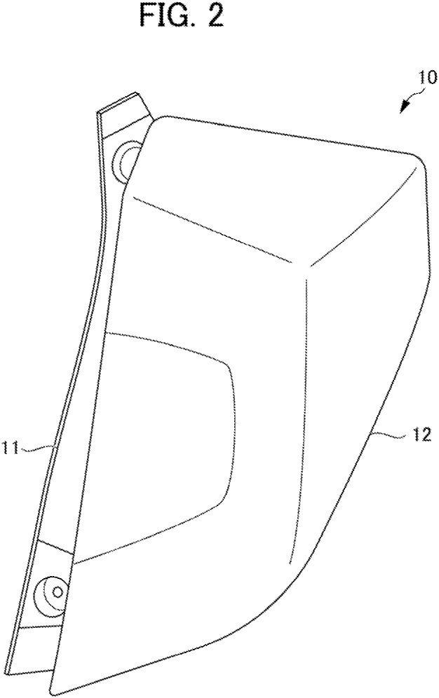

FIGS. 1A, 1B, and 2 each show a tail light as an example of a lamp body of an embodiment of the present embodiment. FIG. 1B is an enlarged view of a region enclosed by the broken line in FIG. 1A.

A tail light 10 includes a housing 11 attached to a vehicle body B, and a lens 12. At this time, the lens 12 includes a rib 12b joined to a lens body 12a and the housing 11, whereby the rigidity of the tail light 10 is high. Furthermore, the rib 12b is a heat-generating region including a filler 12c capable of generating heat by irradiation with an electromagnetic wave. Therefore, it is possible to separate the lens 12 in a region closer to the joint portion with the housing 11 when recycling the tail light 10, a result of which, the recovery rate of the lens 12 increases. Here, when the rib 12b is irradiated with an electromagnetic wave when the tail light 10 is recycled, the filler 12c absorbs the electromagnetic wave and generates heat, but the rib 12b hardly diffuses heat. As a result, since the rib 12b is likely to soften or melt, the lens body 12a can be easily separated.

At this time, the lens 12 has a projecting shape with respect to the vehicle body B, and the housing 11 has a pressure adjustment hole. Therefore, when a lamp chamber including the housing 11 and the lens 12 is pressurized through the pressure adjustment hole, the lens body 12a can be easily separated. It is to be noted that the pressure adjustment hole is normally sealed with a moisture-proof ventilation sheet, and is provided in order to adjust the pressure of the lamp chamber.

Here, in the tail light 10, a light source 13 is detachably attached to the housing 11. The housing 11 is fixed to the vehicle body B by a fastening bolt F and a fastening clip C.

The material of the housing 11 is not particularly limited, and examples thereof include ABS resin (acrylonitrile-butadiene-styrene resin), ASA resin (acrylonitrile-styrene-acrylate resin), and PP resin (polypropylene resin).

The material of the lens 12 is not particularly limited, and examples thereof include a thermoplastic resin such as acrylic resin and PC resin (polycarbonate resin).

The method of joining the housing 11 and the lens 12 is not particularly limited, and examples thereof include welding, adhesion, and bolt fastening.

The material of the filler 12c is not particularly limited as long as it can generate heat by irradiation with an electromagnetic wave, and examples thereof include carbon black, carbon fiber, ferrite, silicon nitride, and barium titanate.

A heat-generating region including the filler 12c capable of generating heat by irradiation with an electromagnetic wave may be provided in a portion of the rib 12b. Furthermore, a coating layer capable of generating heat by irradiation with an electromagnetic wave may be provided on at least a portion of the rib 12b.

The coating layer is not particularly limited as long as it can generate heat by irradiation with an electromagnetic wave, and examples thereof include a resin layer containing barium titanate, carbon, carbon fiber, SiC, ferrite, acrylic, polyamide, iron, aluminum, and the like; and a metal plated layer containing iron, aluminum, and the like.

Examples of the electromagnetic wave applied to the ribs 12b include microwaves and lasers. Examples of the laser include a CO₂ laser, a diode laser, and a YAG laser.

The light source 13 is not particularly limited, and examples thereof include a discharge lamp, a halogen bulb, and an LED.

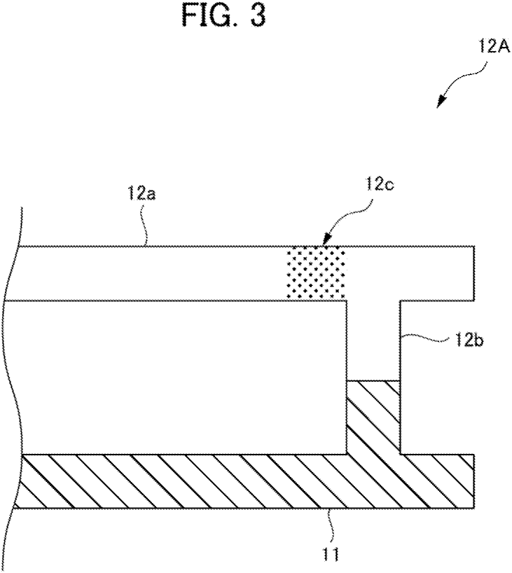

FIG. 3 shows a modified example of the lens 12.

A lens 12A is similar to the lens 12 except that a heat-generating region including the filler 12c capable of generating heat by irradiation with an electromagnetic wave is provided in the vicinity of the inner side in the plane direction with respect to the rib 12b of the lens body 12a. With such a configuration, when the tail light 10 is recycled, the heat-generating region is easily irradiated with the electromagnetic wave, whereby the heat-generating region tends to soften or melt. Furthermore, since the rigidity of the region of the lens body 12a in contact with the rib 12b is high, stress is easily applied to the lens body 12a. As a result, the lens body 12a can be easily separated.

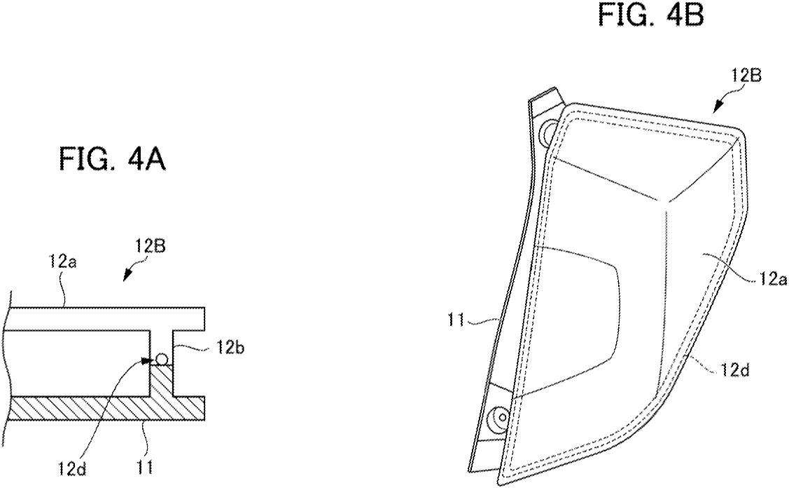

FIGS. 4A and 4B each show a modified example of the lens 12.

A lens 12B is similar to the lens 12 except that a heater wire 12d functioning as a conductive member capable of generating heat by resistance heating is provided in a portion of a region of the rib 12b joined to the housing 11 instead of the heat-generating region including the filler 12c capable of generating heat by irradiation with an electromagnetic wave. At this time, the heater wire 12d is connectable to a power source. Therefore, when the heater wire 12d is connected to the power source and an electric current is passed through the heater wire 12d when the tail light 10 is recycled, the heater wire 12d generates heat. As a result, the rib 12b in the vicinity of the heater wire 12d is softened or melted, and the lens body 12a is easily separated.

The diameter of the heater wire 12d is preferably 1 mm or less. This improves the bonding strength between the lens 12B and the housing 11.

The material of the heater wire 12d is not particularly limited, and examples thereof include nichrome, graphite, and an iron-chromium alloy.

The lamp body of an embodiment of the present invention is not limited to the tail light, and may be, for example, a head light, a direction indicator, a high mount stop lamp, or the like.

Furthermore, in the lamp body of an embodiment of the present invention, the lens may have a soluble region which can be dissolved by a solvent instead of the heat-generating region.

For example, the rib 12b of the lens 12 may be in a soluble region. In such a case, since the solubility of the rib 12b is higher than the solubility of the lens body 12a, when the solvent is brought into contact with the rib 12b when the tail light 10 is recycled, the rib 12b swells or dissolves, and the lens body 12a is easily separated.

The solvent is not particularly limited, and examples thereof include ethanol, methanol and acetone.

When ethanol is used as the solvent, examples of the material of the rib 12b include acrylic resin, polycarbonate (PC), polyvinyl chloride (PVC), polystyrene (PS), and polyphenylene ether (PPE).

When the solvent is brought into contact with the rib 12b, it may be heated as necessary.

Although embodiments of the present invention have been described above, the present invention is not limited to the above-described embodiments, and the above-described embodiments may be appropriately modified within the scope of the present invention.

### EXPLANATION OF REFERENCE NUMERALS

10 tail light
11 housing
12, 12A, 12B lens
12a lens body
12b rib
12c filler
12d heater wire
13 light source
B vehicle body
C fastening clip
F: fastening bolt

What is claimed is:

1. A lamp body comprising:
a housing to be attached to a vehicle body; and
a lens joined to the housing,
wherein the lens includes a heat-generating region that allows for heat generation.

2. The lamp body according to claim 1, wherein the heat-generating region is provided in a region of the lens joined to the housing, or in a vicinity of the region.

3. The lamp body according to claim 2, wherein
the lens includes a rib joined to a lens body and the housing, and
the heat-generating region is provided in the rib.

4. The lamp body according to claim 1, wherein
the lens includes a rib joined to a lens body and the housing, and
the heat-generating region is provided in a vicinity of an inner side in a plane direction with respect to the rib of the lens body.

5. The lamp body according to claim 1, wherein the heat-generating region includes a filler capable of generating heat by irradiation with an electromagnetic wave, or a coating layer capable of generating heat by irradiation with an electromagnetic wave thereon.

6. The lamp body according to claim 1, wherein
the heat-generating region is a conductive member capable of generating heat by resistance heating, and
the conductive member is connectable to a power source.

7. The lamp body according to claim 1, wherein the lens includes a soluble region which can be dissolved by a solvent instead of the heat-generating region.

8. The lamp body according to claim 1, wherein
the lens has a projecting shape with respect to the vehicle body, and
the housing includes a pressure adjustment hole.
